(19) United States
(12) Patent Application Publication
(10) Pub. No.: US 2020/0143428 A1
(43) Pub. Date: May 7, 2020

(54) System And Method For Grouped Targeted Advertising Using Facial Recognition And Geo-Fencing

(71) Applicant: Toyota Motor North America, Inc., Plano, TX (US)

(72) Inventors: Trent Bennett, Prosper, TX (US); Joshua Batie, Frisco, TX (US)

(21) Appl. No.: 16/177,589

(22) Filed: Nov. 1, 2018

(51) Int. Cl. G06Q 30/02; G06K 9/00; H04W 4/021

(52) U.S. Cl. CPC G06Q 30/0269; H04W 4/021; G06K 9/00288; G06Q 30/0261

(57) ABSTRACT

Methods and systems of the present disclosure provide targeted advertisements to customers using facial recognition data and the number of customers present in a geo-fenced area. The system includes a customer detection module to detect the presence of customers in the geo-fenced area. Upon detection of the customers, an image collection system is activated to obtain images of the customers to generate facial recognition data. Using the facial recognition data, the system determines the number of customers in the geo-fenced location and then compares the number to a threshold number of customers. If the number of customers meets and/or exceed the threshold number, the facial recognition data is then used to determine various characteristics of the customers. The system then selects advertisements for the customers based on their characteristics. The advertisements are then transmitted to the customers.

### FIELD OF THE DISCLOSURE

The present disclosure generally relates to systems for targeted advertising and, more particularly, to systems which target advertising using facial recognition and geo-fencing.

### BACKGROUND

Targeted advertisements are currently used in various forms of marketing. Some existing methods involve using second-order proxies for targeting, such as tracking online or mobile web activities of consumers, associating historical web page use or consumer demographics with new consumer web page access, and using searched keywords as the basis for implied interest or contextual advertising. However, these targeted advertising techniques are sometimes limited by requiring some form of initial human involvement such as, for example, a user entering keywords into a search engine.

### SUMMARY

In view of the foregoing disadvantages, the present disclosure provides computer-implemented methods for presenting targeted advertisements to a group of customers. A customer detection module detects the presence of one or more customers in a geo-fenced area. Upon detection of the customers, an image collection system in communication with the customer detection module is activated to obtain images of the customers to thereby generate facial recognition data and store the facial recognition data in an image repository. A processor of the image collection system determines the number of customers in the geo-fenced area based on the images of the customers, then compares the number of customers to a threshold number of customers stored in memory of the image collection system. In response to the number of customers meeting or exceeding the threshold number, the processor determines characteristics of the customers using the facial recognition data and, based upon the determined characteristics, selects advertisements for the customers. The system then transmits a signal over the network to an advertisement presentation device, the signal including an instruction to present the advertisements to the customers.

In certain other methods, the method as defined in claim 1, a first advertisement is transmitted when a first number of customers are present in the geo-fenced area, and a second advertisement, different from the first advertisement, is transmitted when a second number of customers are present in the geo-fenced area, the second number being larger than the first number. In other examples, the advertisements are selected based upon a common characteristic of the customers. The presence of the customers may also be detected using at least one of a motion sensor or mobile device sensor. In yet other methods, a first advertisement is transmitted to a first customer based upon a proximity of the first customer to a first product within the geo-fenced area, the first advertisement being related to the first product, and a second advertisement is transmitted to a second customer based upon a proximity of the second customer to a second product within the geo-fenced area, the second advertisement being related to the second product.

In other methods, the geo-fenced area is defined by a proximity to a product and the advertisements are selected based upon an amount of time the customers are present in the geo-fenced area. In yet others, the geo-fenced area is defined as a retail store or an area within a proximity to a beacon. The advertisement presentation device may be a product display adjacent the customers, a speaker, or a mobile device of the customers.

An illustrative system of the present disclosure may include a customer detection module to detect a presence of one or more customers in a geo-fenced area, an image collection system in communication with the customer detection module and activated in response to customer detection to thereby obtain images of the customers and generate facial recognition data, and a processor communicably coupled to the customer detection module. The processor performs operations comprising to perform operations comprising determining a number of customers in the geo-fenced area based on the facial recognition data, comparing the number of customers to a threshold number stored in a memory of the system, in response to the number of customers meeting or exceeding the threshold number, determining characteristics of the customers using the facial recognition data, based upon the determined characteristics, selecting advertisements for the customers, and transmitting a signal over a network to an advertisement presentation device, the signal including an instruction to present the advertisements to the customers.

The geo-fenced area may be defined as a retail store or an area within a proximity to a beacon. The advertisement presentation device may be a product display which receives and displays the transmitted advertisements, a speaker which audibly presents the advertisements, or a customer mobile device which receives and displays the transmitted advertisements.

An alternate system of the present disclosure may include a customer detection module to detect a presence of one or more customers in a geo-fenced area defined as a retail store or an area within a proximity to a beacon, the customer detection module being at least one of a motion sensor or mobile device sensor; an image collection system in communication with the customer detection module and activated in response to customer detection to thereby obtain images of the customers and generate facial recognition data; an advertisement presentation device to present advertisements to the customers in an audio or visual form; and a processor communicably coupled to the customer detection module and advertisement presentation device. The process may perform operations including determining a number of customers in the geo-fenced area based on the facial recognition data, comparing the number of customers to a threshold number stored in a memory of the system, in response to the number of customers meeting or exceeding the threshold number, determining common characteristics of the customers using the facial recognition data, based upon the determined common characteristics, selecting advertisements for the customers; and, transmitting a signal over a network to the advertisement presentation device, the signal including an instruction to present the advertisements to the customers.

Another aspect of the present disclosure provides a non-transitory computer-readable medium having stored thereon machine-readable instructions executable to cause a machine to perform any of the methods described herein.

### BRIEF DESCRIPTION OF THE DRAWINGS

FIG. 1 is a block diagram depicting a system to facilitate targeted advertisements, according to certain illustrative embodiments of the present disclosure;

FIG. 2 illustrates a top side view of a geo-fenced area forming part of the system of FIG. 1, according to certain illustrative embodiments of the present disclosure;

FIG. 3 is another top-side view of a geo-fenced area having micro geo-fenced areas therein, according to an alternative embodiment of the present disclosure; and

FIG. 4 is a flow chart for a computer-implemented method to target advertisements, according to certain illustrative methods of the present disclosure.

### DESCRIPTION OF ILLUSTRATIVE EMBODIMENTS

Illustrative embodiments and related methods of the present disclosure are described below as they might be employed in a system and method for targeted advertising. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure. Further aspects and advantages of the various embodiments and related methods of the disclosure will become apparent from consideration of the following description and drawings.

As described herein, methods and systems of the present disclosure provide targeted advertisements to customers using facial recognition data and the number of customers present in a geo-fenced area. A “geo-fence” is a virtual space which corresponds to a geographical physical location (e.g., a retail store). In a generalized method of the present disclosure, the system includes a customer detection module which detects the presence of one or more customers in a geo-fenced area. Upon detection of the customers, an image collection system is activated to obtain images of the customers to thereby generate facial recognition data. Using data received from the customer detection module and/or the facial recognition data, the system determines the number of customers in the geo-fenced location. The number of customers is then compared to a threshold number of customers stored in system memory. If the system determines the number of customers meets and/or exceeds the threshold number, the facial recognition data is then used to determine various characteristics of the customers. The system then selects advertisements for the customers based on their characteristics. The advertisements are then transmitted to the customers in a variety of ways.

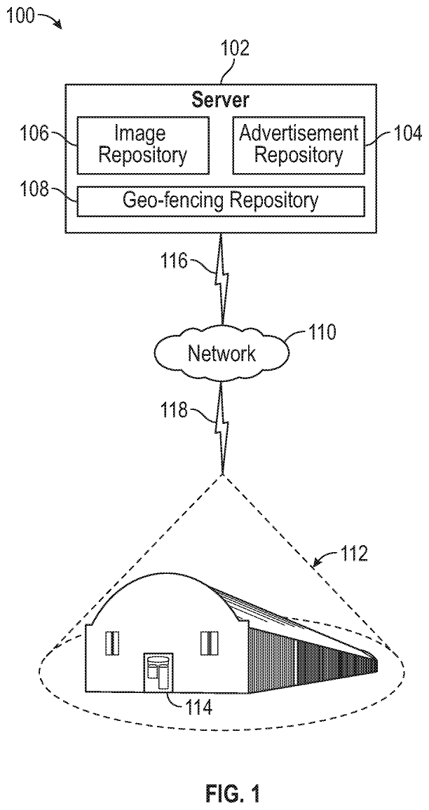

FIG. 1 is a block diagram depicting a system 100 to facilitate targeted advertisements, according to certain illustrative embodiments of the present disclosure. The illustrated system 100 includes a server 102, an advertisement repository (or database) 104, facial image repository 106, and a geo-fencing repository 108. All components of server 102 are communicatively coupled to one or more geo-fenced area 112 via a network 110. While FIG. 1 depicts the server 102, advertisement repository 104, facial image repository 106, and geo-fencing repository 108 as independent components, in further embodiments, various structure, acts, and/or functionality of these components may be combined and/or integrated into the same computing device and/or system.

The network 110 can be a variety of communication networks including for example, wired or wireless, and may have numerous different configurations including a star configuration, token ring configuration, or other configurations. The network 110 may include one or more networks or network types. For instance, the network 110 may include one or more local area networks (LAN), wide area networks (WAN) (e.g., the Internet), public networks, private networks, virtual networks, telecommunication networks, near-field networks, peer-to-peer networks, and/or other interconnected data paths across which multiple devices may communicate. The network 110 may exchange data in a variety of different standard and/or proprietary communication protocols, such as HTTP, HTTPS, SSH, FTP, SFTP, WebSocket, SMS, MMS, WAP, VOIP, email protocols, direct data connection, WAP, various email protocols, etc.

The server 102, advertisement repository (or database) 104, facial image repository 106, and a geo-fencing repository 108 may include one or more hardware and/or virtual servers and/or storage devices. These servers and/or repositories 102, 104, 106 and 108 are capable of processing, storing, sending and receiving data. These servers and/or repositories 102, 104, 106 and 108 may include one or more processors, memories, and physical and/or virtual network communication devices. As depicted in FIG. 1, servers and/or repositories 102, 104, 106 and 108 may be respectively electronically communicatively coupled to the network 110 via signal line 116 for data communication and virtual interaction with one another and the other components of the system 100, such as system components of geo-fenced area 112, as will be described below. The geo-fenced area 112 is communicably coupled to server 102 via network 110 over communications line 118. In this example, geo-fenced area 112 is a retail location 114. However, in alternate embodiments, geo-fenced area 112 may be any geographic location containing the necessary systems to enable the geo-fencing functions as described herein.

Geo-fencing repository 108 enables system 100 to create, monitor, and communicate with enabled computing devices in geo-fenced area 112. As will be described below, such computing devices can include, for example, mobile devices, image collection systems, or customer detection modules, each of which are enabled to communicate with server 102. A variety of geo-fencing techniques may be used in embodiments of the present disclosure.

A geo-fence is a virtual space corresponding to a physical, or geographical, location. The geographical location tracked by a single geo-fence can correspond to areas of different sizes. For example, a geo-fence can include a retail location, home, workplace, or any other location of larger or smaller sizes. For example, a geo-fence may also be a section of a retail store (e.g., men's section) or the area adjacent a particular product. In certain illustrative embodiments, a geo-fence can be established by defining a center-point and a radius distance from the center-point, which determines the overall geographical area covered by the geo-fence. Usually, the center-point will be the location of interest for the geo-fence. In other examples, a geo-fence can take other shapes, such as a rectangle, square, polygon, or other shape. As will be described in certain illustrative embodiments herein, when a device enters or exits a geo-fence, an activation signal is generated by system 100, thereby activating an image collection system located within the geo-fenced area. Once the images are captured, the facial recognition data is transmitted over network 110 for further analysis and selection of targeted advertisements, as described below.

Although not shown in FIG. 1, system 100 also includes the necessary source data to enable the system. When the geo-fenced area 112 includes a large geographical area, such source data may include GPS data, cellular tower data, or any combination of these necessary to generate, identify, locate, or monitor each geo-fenced area. In other examples when the geo-fenced area 112 includes a smaller area (e.g., near a product or section of a retail location), the data may be sourced using Bluetooth, NFC, Wi-Fi, or other radio data. Since there may be hundreds of geo-fenced areas being monitored by server 102, the geographical source data (GPS or Wi-Fi, e.g.) may be used to identify the size of the specific geo-fenced area. Further details of geo-fencing will not be described herein, as the implementation of such techniques will be well understood by those ordinarily skilled in the art having the benefit of this disclosure.

Still referencing FIG. 1, advertisement repository 104 may include a variety of ads and digital content. Such ads and other digital content may include textual ads, graphical ads, videos, music, podcasts, images, etc. related to various products, merchandise, etc. Advertisement repository 104 may also be communicably coupled to a third-party merchant system whereby the ads or other content are sourced. In other embodiments, advertisement repository 104 may be a data storage for such advertisements. Nevertheless, the data stored thereon may be stored in a suitable memory and/or another non-transitory storage device or system distinct therefrom.

Image file repository 106 includes stored images of individuals and their corresponding characteristic information. Such characteristic information may include the identity of the person represented by the image data (e.g., name, address, etc.). Alternatively, the characteristic information may be demographic in nature such as, for example, the ethnicity or age of the person represented by the image data. Image file repository 106 may also interface/communicate with other related identification databases such as, for example, a department of motor vehicle database. In certain other embodiments, image file repository 106 also includes the imaging logic necessary to identify demographic and other facially related characteristics of individuals.

Each component of server 102, and all other computing devices described herein, may be implemented with or without a processor and/or a memory. For example, any of the repositories 104, 106 and 108 may include their own processor, while in other examples neither may include their own dedicated processor. In the case of the latter, server 102 or some other component may include the necessary processor to control all logic described herein in a distributed computing arrangement.

The processors described herein may include any device capable of executing machine readable instructions. Accordingly, each processor may be a controller, an integrated circuit, a microchip, a computer, or any other computing device. The memory described herein may be RAM, ROM, a flash memory, a hard drive, or any device capable of storing machine readable instructions. The logic that includes machine readable instructions or an algorithm written in any programming language of any generation (e.g., 1GL, 2GL, 3GL, 4GL, or 5GL) such as, e.g., machine language that may be directly executed by the processor, or assembly language, object-oriented programming (OOP), scripting languages, microcode, etc., that may be compiled or assembled into computer-readable instructions and stored on a non-transitory computer-readable medium. Alternatively, the logic or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, or as a combination of hardware and software components.

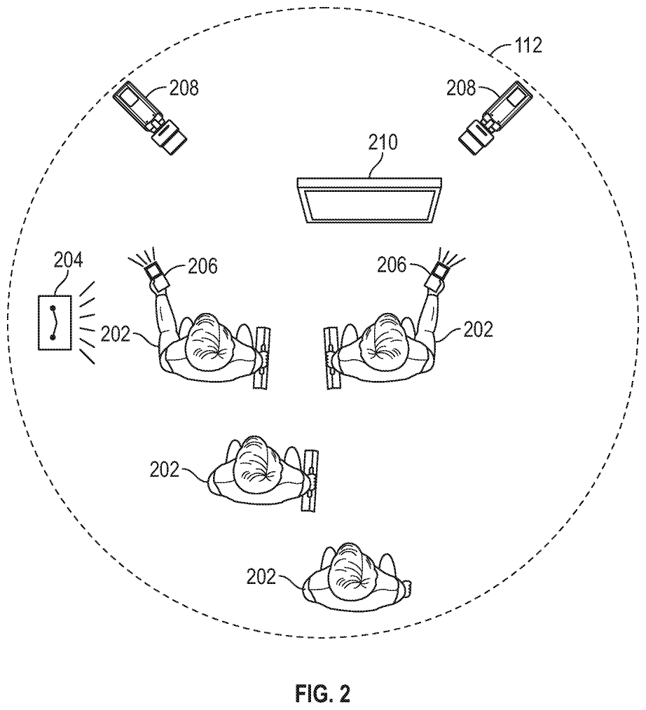

FIG. 2 illustrates a top side view of a geo-fenced area 112 forming part of system 100, according to certain illustrative embodiments of the present disclosure. In this example, geo-fenced area 112 is a retail store in which a plurality of customers 202 have entered. Although described as “customers” herein, the present disclosure may be used to identify and target ads toward any persons capable of being facially identified. In certain embodiments, a customer detection module 204 is positioned in a suitable location in order to detect the presence in of customers 202. For example, customer detection module 204 may be located at the entrance of the retail store or near the entrance of the men's section of the store. The customer detection module 204 may be a variety of systems designed to detect the presence of individuals such as, for example, a motion sensor, biometric sensor, or a mobile device sensor. Thus, in certain embodiments, the presence of customers 202 may be detected by motion, biometric reading, or via detection of their mobile devices 206.

An image collection system 208 is also positioned inside geo-fenced area 112 and communicably coupled to customer detection module 204. The image collection system may include one or more image collection devices, which in the embodiment shown is one or more cameras. In this example, image collection system 208 is comprised of two cameras or other suitable image collection devices such as, for example, closed circuit television or security cameras. Although only two cameras are shown, any number of cameras or other image collection devices may be included in system 208, each being positioned to obtain facial recognition data of customers 202. In certain examples, image collection system 208 remains in an inactive state until an activation signal is transmitted from customer detection module 204. In other examples, image collection system 208 continuously runs and captures imaging data in order to achieve the intents of the present disclosure.

Image collection system 208 and customer detection module 204 are each communicably coupled to server 102 over network 110 via link 118 (FIG. 1). During operation of a generalized method, when customers 202 enter geo-fenced area 112, customer detection module 204 detects the presence of each using, for example, motion sensing, biometric sensing, or detection of mobile devices 206. In certain methods, a combination of various detection methods are used in order to detect all customers present in geo-fenced area 112 (since some may not have a mobile device). For example, in one scenario, a motion detector may only detect movement at the entry, but not the number of persons moving—nevertheless, customer detection module 204 transmits an activation signal to image collection system 208 whereby images of each customer 202 are obtained and used to identify the number of customers 202.

In another scenario, customer detection module 204 may detect the presence of mobile devices 206. However, since there are only two mobile devices 206 in FIG. 2, the other two customers 202 may not be detected by the customer detection module. Nevertheless, customer detection module 204 will still transmit an activation signal to image collection system 208 once mobile devices 206 are detected. In response, image collection system 208 then captures images of each customer 202, which are then used by the system 100 to determine the accurate number of customers 202 in geo-fenced area 112.

Image collection system 208 uses the images to generate corresponding image recognition data using any suitable facial recognition technique. In certain embodiments, this processing may be performed using processors resident in geo-fenced area 112. In other embodiments, the image data is transmitted to server 102 where image repository 106 and geo-fencing repository 108 are used to determine the number, identity, and/or demographic characteristics of customers 202. The description below, however, will focus on server 102 acting as the processor for the described methods.

Once server 102 receives the facial recognition data, server 102 begins processing the data according to the illustrative methods of the present disclosure. In certain methods, server 102 first determines the number of customers 202 in geo-fenced area 112. As previously mentioned, the number of customers 202 may be determined by image repository 106 using the facial recognition data (e.g., identified by their faces). So, in the example of FIG. 2, 4 faces are identified which then means four customers are present. In certain embodiments, the image data may also be compared to the image data in repository 108 until a match is found in order to provide more detail on a specific customer demographic. For example, if the identity of a customer is determined, server 102 may retrieve historical records of the customers (e.g., products purchased, retail locations visited, time spent in a given retail location, etc.). Such historical information allows system 100 to better target specific advertisements to that customer.

Server 102 then compares the number of customers 202 to a threshold number of customers. Here, for example, to efficiently allocate advertising capital, Merchant A may only want to advertise product A if there are four or more customers present in the geo-fenced area 112. However, another Merchant B may only want to advertise product B if ten or more customers are present. The threshold number may be any number in other embodiments. This customer threshold data may be stored on server 112 (e.g., in advertising repository 104) and retrieved when facial recognition data is received. In the example of FIG. 2, server 102 determines four customers 202 are present, Merchant A's advertising content is retrieved (but not Merchant B's) and transmitted via network 110 to mobile devices 206 for presentation to customers 202.

As mentioned above, the use of the customer thresholds for advertising provides the ability to effectively allocate advertising capital. A merchant is able to set a threshold number of customers which must be present in a geo-fence in order to advertise the merchant's products. Moreover, the merchant can set a threshold number of customers for certain products, while setting a different threshold for other products.

In certain other embodiments, after server 102 determines the number of customers 202 and that number is compared against the threshold numbers for the merchant ad content present on server 102, the facial recognition data is used to further target the ads. For example, the image recognition data may be used to determine characteristics of the customers 202. Such characteristics may include, for example, an ethnicity, hair texture or color, age, or gender of the customers. These characteristics may then be matched with relevant ads. For example, a male customer may be interested in facial hair grooming products, thus prompting server 102 to retrieve ads of Merchant A relevant to facial hair grooming. In other examples, a curly hair texture may prompt server 102 to retrieve hair product ads targeted toward more curly hair textures. In certain methods, the characteristic of a single customer 202 within the group of customers may be used to identify the ad to be transmitted.

In other alternative methods, server 102 may determine common characteristics held among the group of customers 202 and identify ads accordingly. For example, a common characteristic held by the group may be they are all of the same ethnicity, age group, gender, have similar hair textures/colors, etc. These commonly-held characteristics of customers 202 may be determined by server 102 using the image collection system, then used to identify ads relevant to those common characteristics. Thus, in the example where the common characteristic is age (e.g., between the ages of 40-50 years), ads directed to middle age products may be identified by server 102.

In yet other embodiments, the characteristics of the customer group may be combined with thresholds in order to target advertising. For example, a merchant may determine it wants a certain number of customers having certain characteristics to be present within the geo-fenced area before a specific ad is advertised. A merchant of hair care products may set a threshold number of ten customers who must also have certain ethnic facial features before the merchant's ads are transmitted. Any variety of illustrative customer thresholds and facial characteristics may be combined to target advertisements. Thereafter, server 102 retrieves the relevant ad from advertisement repository 104 and transmits it for presentation to the customer 202. More specifically, server 102 may transmit the ad along with a signal including an instruction to display or otherwise present the ad to customers 202 via an advertisement presentation device (e.g., in an audible or visual form). Using an advertisement presentation device, the ads may be presented in a variety of ways. For example, the advertisement presentation device may be a display device of a device capable of audibly communicating the ad (e.g., speakers). In certain embodiments, mobile devices 206 are enabled to communicate with server 102 and may display or otherwise communicate the ads to those customers 202 via mobile devices 206. In another embodiment, the ads are transmitted to a product display 210 located adjacent to customers 202 in geo-fenced area 112 so that all customers 202 are presented with the ad. Product display 210 may be, for example, a display screen, hologram, or other image display device. In yet other examples, speakers (not shown) may audibly present the ads to customers 202.

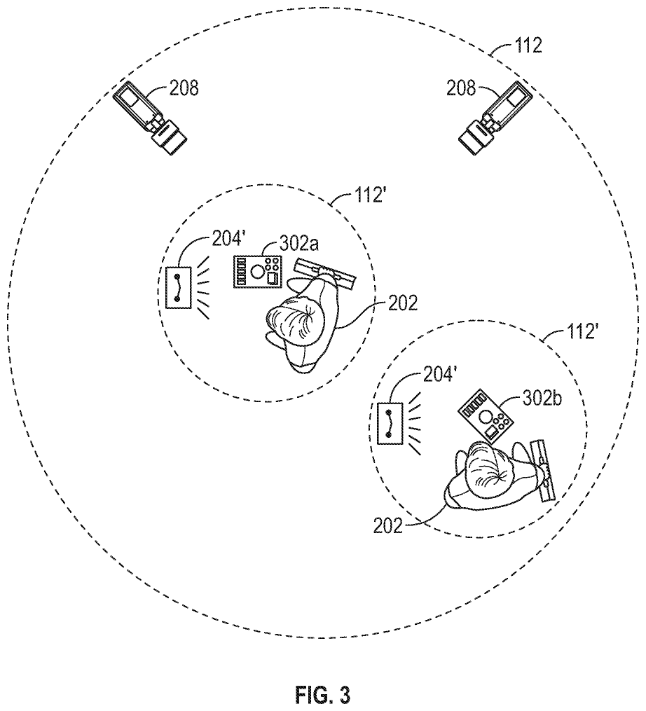

FIG. 3 is another top-side view of geo-fenced area 112 having micro geo-fenced areas 112′ therein, according to an alternative embodiment of the present disclosure. In this example, a number of small geo-fenced areas, or micro geo-fenced areas 112′ are present inside geo-fenced area 112. The micro geo-fenced areas 112′ may be created in similar fashion to geo-fenced area 112. Alternatively, micro geo-fenced areas 112′ may be created using beacon geo-fencing. Beacon geo-fencing refers to a location that can be identified as an area near/proximate a physical device or beacon. Some sources of proximity geofences usable by the system include Bluetooth, NFC, Wi-Fi, or other radios. Further description of beacon geo-fencing will not be described herein, as those ordinarily skilled in the art having the benefit of this disclosure will readily understand its application to the present disclosure. Thus, in the example of FIG. 3, an alternative embodiment uses products 302a and 302b as beacons to define micro geo-fenced areas 112′.

As shown in FIG. 3, each micro geo-fenced areas 112′ includes a customer detection module 204′ are previously described to detect the presence of customers 202 inside micro geo-fenced areas 112′ using, for example, motion or mobile device detection methods. Once detected, customer detection module 204′ sends an activation signal to image collection system 208 as previously described, to thereby capture images of customers 202. Thereafter, the image data is transmitted to server 102 and system 100 determines the number of customers 202 present in micro geo-fenced areas 112′, compares that number to relevant threshold numbers, then selects and transmits targeted advertisements, as previously described.

In one example scenario, when customer 202 enters micro geo-fenced areas 112′ surrounding product 302a (i.e., within proximity to product 302a), system 100 performs any of the methods described herein to select, retrieve and transmit a first advertisement relevant to product 302a to customer 202. Simultaneously, when customer 202 enters micro geo-fenced areas 112′ surrounding product 302b (i.e., within proximity to product 302b), system 100 also performs any of the methods described herein to select, retrieve and transmit a second advertisement relevant to product 302b to customer 202. Although not shown, the targeted ads may be communicated to customer 202 using any of the methods described herein.

In yet other examples of the present disclosure, system 100 may also track the amount of time a customer spends in a particular geo-fenced area. Here, for example, customer detection module 204 may track the amount of time customers 202 spends in geo-fenced area 112. This time tracking information may be used by system 100 or third party marketing platforms to more effectively target ads. For example, if a certain customer spends more time in store A (or a section of store A) versus store B (or a section of store B), system 100 may transmit to that customer ads more relevant to products in the store A. In other examples, system 100 may determine the amount of time a customer spends adjacent one product versus another product and target ads accordingly.

In other embodiments, big data analytics can also be leveraged to collect and analyze image data from multiple cameras (relating to multiple geo-fences and individuals). Big data analytics is the process of examining large and varied data sets (i.e., big data) to uncover hidden patterns, unknown correlations, market trends, customer preferences and other useful information that can help organizations make more-informed business decisions. Thus, embodiments of the present disclosure may use such data to recognize individuals, identify stores (or businesses), and determine associated temporal data (e.g., the amount of time the individual remains near a certain product or in the store prior to exit). Further, as previously mentioned, big data analytics may also be communicated to third-party or marketing systems to further refine targeted advertising.

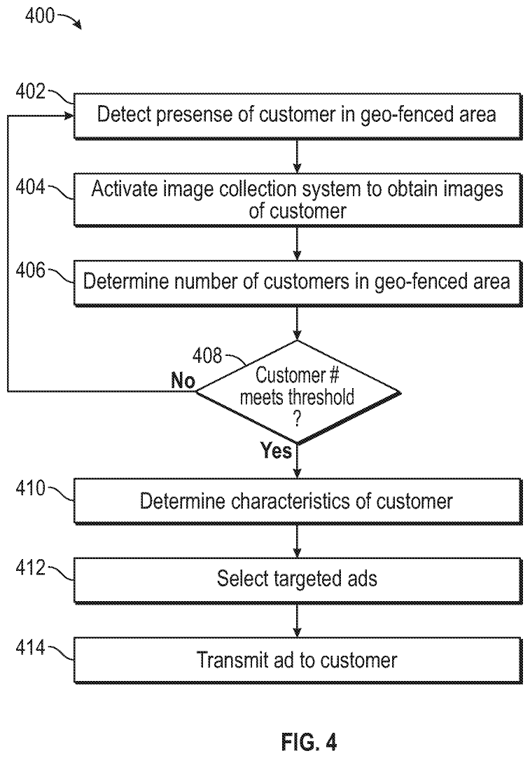

FIG. 4 is a flow chart for a computer-implemented method 400 to target advertisements, according to certain illustrative methods of the present disclosure. At block 402, system 100 detects the presence of one or more customers in a geo-fenced area. At block 404, upon detection of the customers, system 100 activates an image collection system to obtain images of the customers to thereby generate facial recognition data. Alternatively, however, the image collection system may be continuously running and obtaining image data. At block 406, system 100 determines the number of customers in the geo-fenced location. At block 408, system 100 then compares the number of customers to merchant threshold numbers that must be met before a given product advertisement is advertised. If, at block 408, system 100 determines the number of customers present in the geo-fenced area does not meet or exceed the threshold number of a given merchant (e.g., Merchant A), that merchant's ad is not selected, and method 400 loops back to block 402. However, if system 100 determines the number of customers present in the geo-fenced area does meet or exceed the threshold number of Merchant A, that merchant's ad is selected.

In certain alternative methods, at block 410, system 100 then analyzes the facial recognition data to determine characteristics of the customers. Using this characteristic data, system 100 may further refine the selected ads of Merchant A to more efficiently target ads relevant to the customer. For example, if the characteristic data indicates an Asian female, system 100 may select an ad more targeted toward Asian females at block 412. Thereafter, at block 414, system 100 transmits the selected ad(s) for presentation to the customer.

In yet other illustrative methods, the ads may be transmitted in real-time or at other times. For example, system 100 may perform blocks 402-412 while a customer is in a geo-fenced area, but transmit the ad to that customer (or group of customers) at a later time. In such cases, the ads may be presented to the user via a mobile device or some other computing device enabled to communicate with system 100. Such other computing devices may include vehicle or home display systems.

Although various embodiments and methods have been shown and described, the disclosure is not limited to such embodiments and methods and will be understood to include all modifications and variations as would be apparent to one skilled in the art. Therefore, it should be understood that embodiments of the disclosure are not intended to be limited to the particular forms disclosed. Rather, the intention is to cover all modifications, equivalents and alternatives falling within the spirit and scope of the disclosure as defined by the appended claims.

What is claimed is:

1. A method of presenting targeted advertisements to a group of customers, comprising:
detecting with a customer detection module a presence of one or more customers in a geo-fenced area;
upon detection of the customers, activating an image collection system in communication with the customer detection module to obtain images of the customers to thereby generate facial recognition data and store the facial recognition data in an image repository;
determining, by a processor of the image collection system, a number of customers in the geo-fenced area based on the images of the customers;
comparing, by a processor of the image collection system, the number of customers to a threshold number of customers stored in a memory of the image collection system;
in response to the number of customers meeting or exceeding the threshold number, determining characteristics of the customers with the processor of the image collection system using the facial recognition data;
based upon the determined characteristics, selecting advertisements for the customers; and
transmitting a signal over a network to an advertisement presentation device, the signal including an instruction to present the advertisements to the customers.

2. The method as defined in claim 1, wherein:
a first advertisement is transmitted when a first number of customers are present in the geo-fenced area; and
a second advertisement, different from the first advertisement, is transmitted when a second number of customers are present in the geo-fenced area, the second number being larger than the first number.

3. The method as defined in claim 1, wherein the advertisements are selected based upon a common characteristic of the customers.

4. The method as defined in claim 1, wherein the presence of the customers is detected using at least one of a motion sensor or mobile device sensor.

5. The method as defined in claim 1, wherein:
a first advertisement is transmitted to a first customer based upon a proximity of the first customer to a first product within the geo-fenced area, the first advertisement being related to the first product; and
a second advertisement is transmitted to a second customer based upon a proximity of the second customer to a second product within the geo-fenced area, the second advertisement being related to the second product.

6. The method as defined in claim 1, wherein:
the geo-fenced area is defined by a proximity to a product; and
the advertisements are selected based upon an amount of time the customers are present in the geo-fenced area.

7. The method as defined in claim 1, wherein the geo-fenced area is defined as a retail store or an area within a proximity to a beacon.

8. The method as defined in claim 1, wherein the advertisement presentation device is a product display adjacent the customers, a speaker, or a mobile device of the customers.

9. A system for targeted advertisements, comprising:
a customer detection module to detect a presence of one or more customers in a geo-fenced area;
an image collection system in communication with the customer detection module and activated in response to customer detection to thereby obtain images of the customers and generate facial recognition data; and
a processor communicably coupled to the customer detection module to perform operations comprising:
determining a number of customers in the geo-fenced area based on the facial recognition data;
comparing the number of customers to a threshold number stored in a memory of the system;
in response to the number of customers meeting or exceeding the threshold number, determining characteristics of the customers using the facial recognition data;
based upon the determined characteristics, selecting advertisements for the customers; and
transmitting a signal over a network to an advertisement presentation device, the signal including an instruction to present the advertisements to the customers.

10. The system as defined in claim 9, wherein:
a first advertisement is transmitted when a first number of customers are present in the geo-fenced area; and
a second advertisement, different from the first advertisement, is transmitted when a second number of customers are present in the geo-fenced area, the second number being larger than the first number.

11. The system as defined in claim 9, wherein the advertisements are selected based upon a common characteristic of the customers.

12. The system as defined in claim 9, wherein the customer detection module is at least one of a motion sensor or mobile device sensor.

13. The system as defined in claim 9, wherein:
a first advertisement is transmitted to a first customer based upon a proximity of the first customer to a first product within the geo-fenced area, the first advertisement being related to the first product; and
a second advertisement is transmitted to a second customer based upon a proximity of the second customer to a second product within the geo-fenced area, the second advertisement being related to the second product.

14. The system as defined in claim 9, wherein:
the geo-fenced area is defined by a proximity to a product; and
the advertisements are selected based upon an amount of time the customers are present in the geo-fenced area.

15. The system as defined in claim 9, wherein the geo-fenced area is defined as a retail store or an area within a proximity to a beacon.

16. The system as defined in claim 9, wherein the advertisement presentation device is:
a product display which receives and displays the transmitted advertisements;
a speaker which audibly presents the advertisements; or
a customer mobile device which receives and displays the transmitted advertisements.

17. A system for targeted advertisements, comprising:
a customer detection module to detect a presence of one or more customers in a geo-fenced area defined as a retail store or an area within a proximity to a beacon, the customer detection module being at least one of a motion sensor or mobile device sensor;
an image collection system in communication with the customer detection module and activated in response to customer detection to thereby obtain images of the customers and generate facial recognition data;
an advertisement presentation device to present advertisements to the customers in an audio or visual form; and
a processor communicably coupled to the customer detection module and advertisement presentation device to perform operations comprising:
determining a number of customers in the geo-fenced area based on the facial recognition data;
comparing the number of customers to a threshold number stored in a memory of the system;
in response to the number of customers meeting or exceeding the threshold number, determining common characteristics of the customers using the facial recognition data;
based upon the determined common characteristics, selecting advertisements for the customers; and
transmitting a signal over a network to the advertisement presentation device, the signal including an instruction to present the advertisements to the customers.

18. The system as defined in claim 18, wherein:
a first advertisement is transmitted when a first number of customers are present in the geo-fenced area; and
a second advertisement, different from the first advertisement, is transmitted when a second number of customers are present in the geo-fenced area, the second number being larger than the first number.

19. The system as defined in claim 18, wherein:
a first advertisement is transmitted to a first customer based upon a proximity of the first customer to a first product within the geo-fenced area, the first advertisement being related to the first product; and
a second advertisement is transmitted to a second customer based upon a proximity of the second customer to a second product within the geo-fenced area, the second advertisement being related to the second product.

20. The system as defined in claim 18, wherein:
the geo-fenced area is defined by a proximity to a product; and
the advertisements are selected based upon an amount of time the customers are present in the geo-fenced area.
